(19) United States
(12) Patent Application Publication
(10) Pub. No.: US 2025/0091649 A1
(43) Pub. Date: Mar. 20, 2025

(54) SIDE STRUCTURE OF VEHICLE BODY

(71) Applicants: Hyundai Motor Company, Seoul (KR); Kia Corporation, Seoul (KR)

(72) Inventors: Won Ki Song, Hwaseong-si (KR); Jaeseung Lee, Hwaseong-si (KR); Hyungsik Choi, Hwaseong-si (KR); Dae Hee Lee, Hwaseong-si (KR); Jin Ho Hwang, Hwaseong-si (KR); Joonghyun Shin, Hwaseong-si (KR); Sun Hyung Cho, Hwaseong-si (KR)

(21) Appl. No.: 18/819,156

(22) Filed: Aug. 29, 2024

(30) Foreign Application Priority Data
Sep. 20, 2023 (KR) 10-2023-0125386

(51) Int. Cl. B62D 25/02; B62D 24/00; B62D 25/04; B62D 27/00; B62D 63/02

(52) U.S. Cl. CPC B62D 25/025; B62D 24/00; B62D 25/04; B62D 27/00; B62D 63/025

(57) ABSTRACT

A side structure of a vehicle body can include a center pillar formed with a center pillar mounting portion supporting a supporter, and a center pillar bracket to which a center pillar bracket mounting portion is formed to support the supporter, and the center pillar bracket connected to the center pillar.

### CROSS-REFERENCE TO RELATED APPLICATIONS

This application claims priority to and the benefit of Korean Patent Application No. 10-2023-0125386 filed in the Korean Intellectual Property Office on Sep. 20, 2023, the entire contents of which are incorporated herein by reference.

### TECHNICAL FIELD

The present disclosure relates to a side structure of a vehicle body.

### BACKGROUND

Recently, the vehicle industry is introducing a new concept of future mobility vision for realizing a human-centered, dynamic future city. One of these future mobility solutions is a Purpose Built Vehicle (PBV) as purpose-based mobility.

A PBV can be an example of an electric vehicle (EV)-based environment-friendly mobile vehicle. This PBV can provide various customized services to users while moving from the starting point to the destination in an unmanned autonomous driving method.

The vehicle body of such a PBV is composed of an under body (also referred to as a rolling chassis or a skateboard in the art) and an upper body assembled to the under body.

Here, the upper body may be configured in various forms according to the type of customized service of PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage room is configured in the rear part.

However, if the structure of the upper body is developed separately according to the various customized services of PBV as described above, manufacturing costs may increase.

Matters described in this background art section are prepared to enhance understanding of the background of the present disclosure, and may include matters other than conventional art already publicly known, available, or in use.

### SUMMARY

The present disclosure relates to a vehicle body. More particularly, the present disclosure relates to a side structure of a vehicle body that can be applied to the production of various vehicle bodies.

An embodiment of the present disclosure can provide a side structure of a vehicle body that can be produced into various types of vehicle bodies depending on the type of PBV's customized service.

A side structure of a vehicle body according to an example embodiment may include a center pillar formed with a center pillar mounting portion supporting a supporter, and a center pillar bracket to which a center pillar bracket mounting portion is formed to support the supporter, and the center pillar bracket connected to the center pillar.

The center pillar may include a center pillar front flange formed in the front direction of the vehicle body, and a center pillar rear flange formed in the rear direction of the vehicle body, and the center pillar bracket may include a center pillar bracket front flange connected to the center pillar front flange, and a center pillar bracket rear flange connected to the center pillar rear flange.

The center pillar bracket mounting portion may be formed in the front direction of the vehicle body of the center pillar bracket.

The center pillar mounting portion may be formed in plural in the rear direction of the vehicle body of the center pillar.

The plurality of center pillar mounting portions may include a center pillar central mounting portion, and the side structure may further include a rear pillar disposed at the rear of the center pillar, and a rear center supporter supported by the center pillar central mounting portion and connected to the rear pillar.

The plurality of center pillar mounting portions may include a center pillar lower mounting portion formed below the center pillar central mounting portion, and the side structure may further include a rear lower supporter disposed below the rear center supporter, supported by the center pillar lower mounting portion, and connected to the rear pillar.

The plurality of center pillar mounting portions may further include a center pillar upper mounting portion formed above the center pillar central mounting portion, and the side structure may further include a rear upper supporter disposed above the rear center supporter, supported by the center pillar upper mounting portion, and connected to the rear pillar, and the rear upper supporter may be disposed in a position corresponding to a glass mount portion formed on the rear of the vehicle body.

The side structure according to an example embodiment may further include a rear pillar disposed at the rear of the center pillar, a one or more rear supporters supported by the center pillar rear mounting portion and connected to the rear pillar, and a one or more rear support bracket mounting the one or more rear supporters to the rear pillar.

The rear pillar may further include a rear pillar flange formed in the front direction of the vehicle body, and the one or more rear support brackets may be connected to the one or more rear supporters, respectively.

The side structure according to an example embodiment may further include a front pillar disposed at the front of the center pillar, and a front supporter supported by the center pillar bracket mounting portion and connected to the front pillar.

The side structure according to an example embodiment may further include a variable part connecting portion mounted on the front pillar, and the front supporter may be disposed toward the variable part connecting portion.

The front pillar may include a front pillar flange formed in the rear direction of the vehicle body, and the side structure may further include a front support bracket surrounding and connecting the front supporter and the front pillar flange.

The side structure according to an example embodiment may further include a door mounting portion supporter that connects a side sill and a roof side, and is mounted between the front pillar and the center pillar.

The door mounting portion supporter may include a first supporter connecting the roof side and the front supporter, and a second supporter connecting the front supporter and the side sill.

The side structure according to an example embodiment may further include a front vertical supporter connecting the front supporter and the side sill.

According to the side structure of a vehicle body according to an example embodiment, it is possible to reduce costs due to producing various types of vehicle bodies.

According to the side structure of a vehicle body according to an example embodiment, the strength of the detachable rear body module can be secured.

In addition, the advantages that can be obtained or expected from an embodiment of the present disclosure can be disclosed directly or implicitly in a detailed description of the disclosure. In other words, various advantages predicted according to a disclosure can be disclosed within the detailed description to be described later.

### BRIEF DESCRIPTION OF THE DRAWINGS

Because these drawings are intended for reference in explaining example embodiments of the present disclosure, technical ideas of the present disclosure are not necessarily limited to the accompanying drawings.

FIG. 1 is a side view showing a side structure of a vehicle body according to an example embodiment of the present disclosure.

FIG. 2 is an exploded perspective view of the side structure of a vehicle body according to an example embodiment of the present disclosure.

FIG. 3 is a perspective view of a variable part applied to the side structure of a vehicle body according to an example embodiment of the present disclosure.

FIG. 4 is a side view of the variable part applied to the side structure of a vehicle body according to an example embodiment of the present disclosure.

FIG. 5 is a perspective view of a front part seen from the outside of the variable section applied to the side structure of a vehicle body according to an example embodiment of the present disclosure.

FIG. 6 and FIG. 7 are perspective views of the front part seen from the inside of the variable part applied to the side structure of a vehicle body according to an example embodiment of the present disclosure.

FIG. 8 is an exploded perspective view of a center pillar of the variable part applied to the side structure of a vehicle body according to an example embodiment of the present disclosure.

FIG. 9 and FIG. 10 are perspective views of a center pillar viewed from the outside of the variable part applied to the side structure of a vehicle body according to an example embodiment of the present disclosure.

FIG. 11 is a perspective view of a rear part seen from the outside of the variable section applied to the side structure of a vehicle body according to an example embodiment of the present disclosure.

FIG. 12 is a perspective view of the rear part seen from the inside of the variable section applied to the side structure of a vehicle body according to an example embodiment of the present disclosure.

FIG. 13 is a cross-sectional view along line A-A in FIG. 3.

FIG. 14 is a cross-sectional view along line B-B in FIG. 3.

FIG. 15 to FIG. 18 are side views showing a vehicle body to which the side structure of a vehicle body according to an example embodiment of the present disclosure has been applied.

The drawings referenced above are not necessarily drawn to scale, and can be understood as presenting a somewhat simplified representation of various features illustrating the principles and example embodiments of the present disclosure. For example, the specific design features of an embodiment of the present disclosure, including specific dimensions, direction, position, and shape, can be determined in part by the specific intended application and usage environment.

### DETAILED DESCRIPTION OF ILLUSTRATIVE EMBODIMENTS

Hereinafter, with reference to the attached drawings, example embodiments of the present disclosure will be described in detail so that those skilled in the art can easily implement the present disclosure. As those skilled in the art can realize, the described example embodiments may be modified in various different ways, all without departing from the spirit or scopes of the present disclosure.

The terminology used herein can be for the purpose of describing specific embodiments and is not intended to necessarily limit the disclosure. As used herein, singular forms can be intended to also include plural forms, unless the context clearly indicates otherwise.

As used herein, the terms “comprise” and/or “comprising” indicate the presence of specified features, integers, steps, operations, elements and/or components, but may also include one or more other features, integers or steps. It also can be understood that this does not exclude the presence or addition of elements, operations, components, and/or groups thereof.

As used herein, the term “and/or” can include any one or all combinations of one or more items listed in association.

In this specification, the term “connected” or “combined” can indicate a physical relationship between two components in which the components are directly connected to each other by welding, rivets, SPR (Self Piercing Rivet), FDS (Flow Drill Screw), structural adhesive, etc., or indirectly connected through one or more intermediate components.

As used herein, ‘vehicle’, ‘vehicular’, ‘automotive’ or other similar terms as used herein can generally refer to passenger vehicles, sports cars, sport utility vehicles (SUVs), buses, trucks, and various commercial vehicles, including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, example embodiments of the present disclosure will be described in detail with reference to the accompanying drawings.

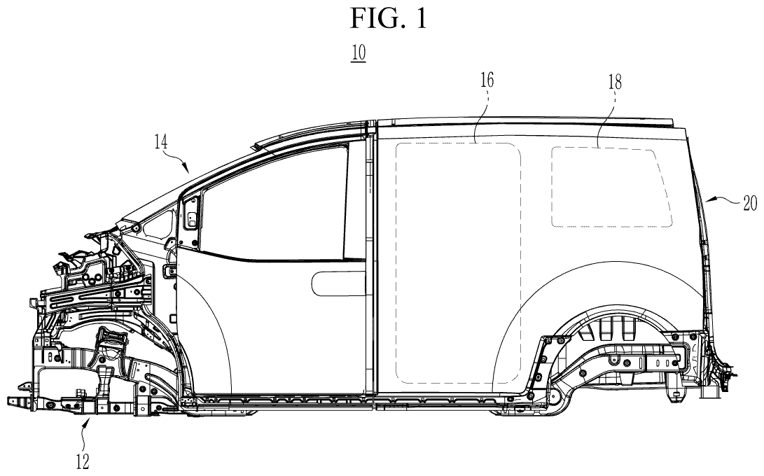

FIG. 1 is a side view showing a side structure of a vehicle body according to an example embodiment.

Referring to FIG. 1, according to an example embodiment, a vehicle body 10 to which a side structure of a vehicle body may be applied may, for example, be a purpose-based mobility vehicle (Purpose Built Vehicle: hereinafter referred to as “PBV”).

The PBV may be used as an electric vehicle-based life module vehicle that provides various services to occupants while moving from one place to a destination in an unmanned self-driving manner.

In one example, the PBV may be manufactured in a one box type design with a large interior space. The PBV may also apply facing type seats to the interior space.

The vehicle body of such a PBV can be suitable for small quantity production of various vehicle types with a small number of parts, and may be manufactured in various shapes and sizes.

The vehicle body of the PBV can include a skateboard-type under body 12 (commonly referred to as a “rolling chassis” or “chassis frame” by those skilled in the art) and an upper body assembled to the under body 12.

The under body 12 may be equipped with components such as a battery assembly and a drive motor. Additionally, the upper body can be a “body-in-white” (BIW, e.g., not finally painted) body that is coupled to the lower body 12, and may include a cabin and luggage room with a large interior space.

In this specification, the “front to rear direction of the vehicle body” can refer to the longitudinal direction of the vehicle body, the “vehicle width direction” can refer to the left-right direction of the vehicle body, and the “up-and-down direction” can refer to the height direction of the vehicle body.

In this specification, “upper end”, “upper portion”, or “upper surface” of a component can indicate an end, portion, or surface of a component that is relatively upper in the drawing, and “lower end”, “lower portion”, or “lower surface” of a component can indicate an end, portion, or surface of a component that is relatively lower in the drawing.

Furthermore, in this specification, an end of a component (e.g., one end or another (other) end, etc.) can denote an end of a component in any one direction, and an end portion of the component (e.g., one end portion) or other (another) end portion, etc.) can denote a portion of a component that includes that end.

According to an example embodiment, the vehicle body 10 can apply an upper body of various shapes and purposes to the under body 12 depending on the type of PBV's customized service.

According to an example embodiment, the vehicle body 10 can have an upper body that includes a front body module 14 and a rear body module 20.

The front body module 14 can include a cab type front cabin. The front body module 14 can be fixed to the front part of the under body 12.

The front body module 14 may be coupled to the front portion of the under body 12 along a vertical direction through a vehicle body mounting unit, such as one known to a person of an ordinary skill in the art. The front body module 14 may be a fixed part fixed to the front portion of the under body 12. The fixed part can be a component coupled to the under body 12, and can be a component that is not replaced even if the purpose of use of the vehicle changes.

The rear body module 20 can be a component that can be replaced depending on the purpose of use of the vehicle, and can be a variable part 20, such as a modular design element.

The side structure of a vehicle body according to an example embodiment may provide a structure that can be commonly applied to various vehicle types. Various vehicle types can be various configurations of the variable part 20, for example, a hailing vehicle for transporting occupants, a delivery vehicle for transporting goods, a special vehicle such as an ambulance, etc.

Requirements for side doors, windows, etc. applied to typical vehicles may vary depending on the type of vehicle, and production costs may increase if separate designs or parts are used for each required configuration.

In FIG. 1, reference numeral 16 can be a door mounting portion, and a vehicle door, for example, a sliding door or a swing-type door, may be mounted on the door mounting portion 16, but the door may not be mounted depending on the vehicle type.

In addition, numeral 18 in the drawing can be a glass mounting portion, and a door window, for example, an open/closed door, or fixed glass may be mounted on the glass mounting portion 18, or a window may not be mounted depending on the type of vehicle.

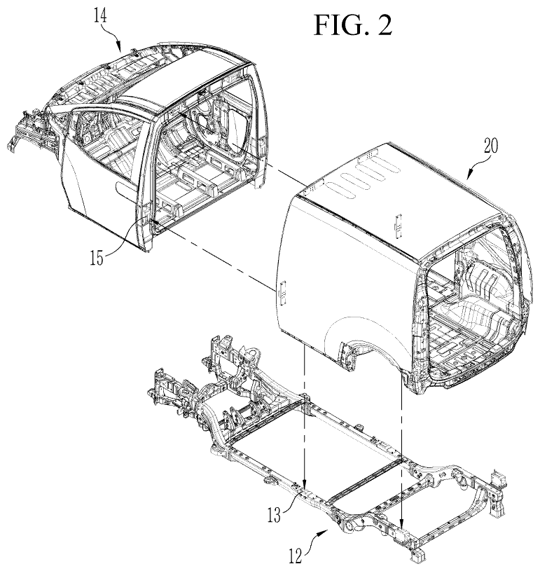

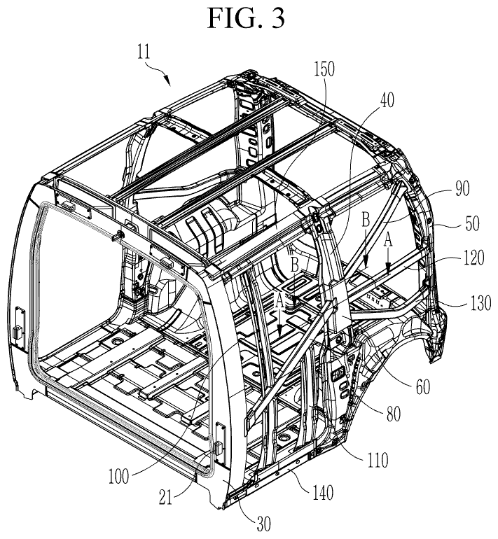

FIG. 2 is an exploded perspective view of the side structure of a vehicle body according to an example embodiment. FIG. 3 is a perspective view of a variable part applied to the side structure of a vehicle body according to an example embodiment.

Referring to FIG. 1 to FIG. 3, the fixed part 14 can be connected to the under body 12, and the fixed part connecting portion 15 can be mounted on the rear thereof.

A under body connecting portion 13 can be mounted on the under body 12.

In the variable part 20, a variable part connecting portion 21, which can selectively connect to the fixed part connecting portion 15, can be mounted on the front of the variable part 20, and a fixed part connecting portion (not shown), which can selectively connect to the under body connecting portion 13, can be mounted at the under part of the variable part 20.

Each “connecting portion” can be a configuration for combining the front body module and/or rear body module of the under body and upper body. For example, the “connecting portion” can be a mechanical configuration that can be connected manually, connected by operation of a separate actuator, and magnetic, etc., and can be connected and/or released depending on the supply of external or internal power. As such, it may be configured for various types of combinations. The configuration and operation of the “connecting portion”, which can connect or disconnect one or more modules or frames, and some detailed explanations thereof can be omitted.

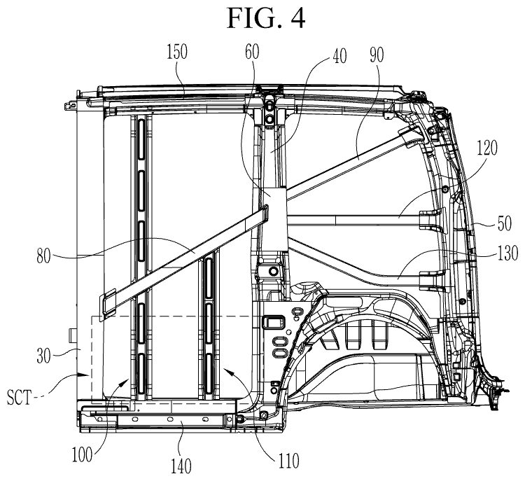

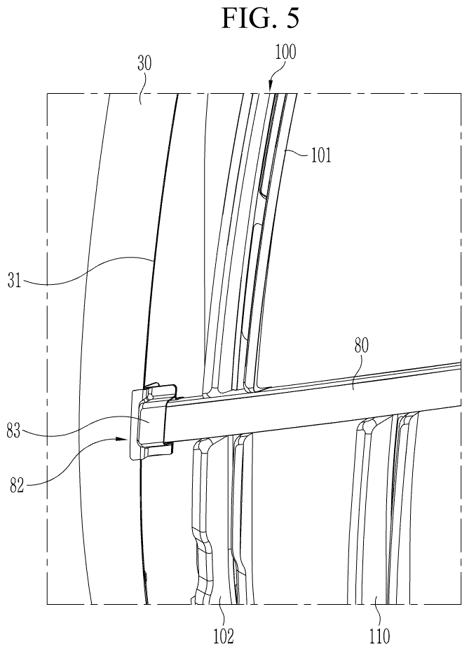

FIG. 4 is a side view of the variable part applied to the side structure of a vehicle body according to an example embodiment. FIG. 5 is a perspective view of a front part seen from the outside of the variable section applied to the side structure of a vehicle body according to an example embodiment.

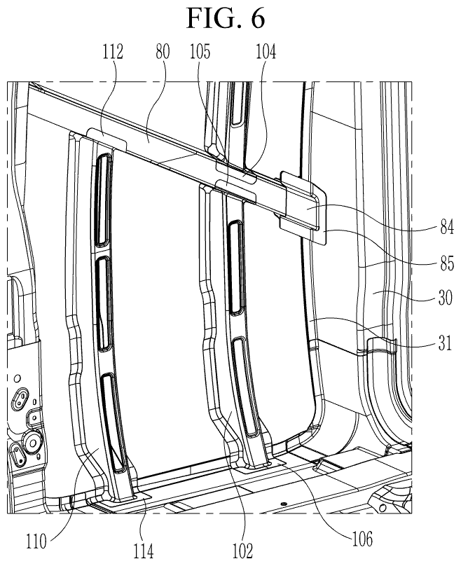

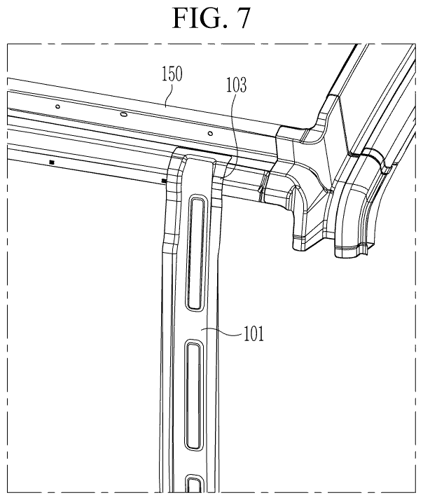

FIG. 6 and FIG. 7 are perspective views of the front part seen from the inside of the variable part applied to the side structure of a vehicle body according to an example embodiment.

Referring to FIG. 1 to FIG. 7, according to an example embodiment, the side structure of a vehicle body may include a center pillar 40, a front pillar 30 disposed on the front of the center pillar 40, and a rear pillar 50 disposed on the rear of the center pillar 40.

The front pillar 30, the center pillar 40, and the rear pillar 50 may be the B pillar, C pillar, and D pillar used in the industry, but are not necessarily limited to these and other pillars, as it can also be applied to vehicles with additions.

A center pillar bracket 60 can be mounted on the center pillar 40. The specific configuration of the center pillar bracket 60 will be described later. According to an example embodiment, the side structure of a vehicle body may include a front supporter 80 supported by the center pillar bracket 60 and coupled to the front pillar 30. The front supporter 80 can be disposed between the front pillar 30 and the center pillar 40, and can be disposed in a position corresponding to the door mounting portion 16.

The front supporter 80 may be placed toward the variable part connecting portion 21. The variable part connecting portion 21 can be a configuration that connects the fixed part 14 and the variable part 20, and can be where the load is concentrated. The front supporter 80 can be disposed toward the variable part connecting portion 21 so that the load in the length direction of the vehicle body may be dispersed.

A front support bracket 82 can connect the front pillar 30 and the front supporter 80. The front support bracket 82 may include, for example, a front support outer bracket 83 and a front support inner bracket 84 connected with the front support outer bracket 83 to surround the front supporter 80.

The front pillar 30 can include a front pillar flange 31 formed in the rear direction of the vehicle body 10, and the front support bracket 82 may surround and connect the front supporter 80 and the front pillar flange 31. In addition, the front support inner bracket 84 can be formed with a front support connecting flange 85, which can be connected to the rear surface of the front pillar 30.

According to an example embodiment, the side structure of a vehicle body can include a roof side 150 mounted on the upper outside of the vehicle body 10 and a side sill 140 mounted on the lower outside of the vehicle body 10, and a door mounting portion supporter 100 connecting the roof side 150 and the side sill 140 may be mounted between the front pillar 30 and the center pillar 40.

The door mounting portion supporter 100 may include a first supporter 101 connecting the roof side 150 and the front supporter 80, and a second supporter 102 connecting the front supporter 80 and the side sill 140.

A door mounting portion roof flange 103 can be formed in the upper part of the first supporter 101 and can be connected to the roof side 150, and a door mounting portion lower flange 104 can be formed in the lower part of the first supporter 101 and can be connected to the front supporter 80.

In addition, a door mounting portion upper flange 105 can be formed in the upper part of the second supporter 102 and can be connected to the front supporter 80, and a door mounting portion side sill flange 106 can be formed in the lower part of the second supporter 102 and can be connected to the side sill 140.

The door mounting portion supporter 100 may connect the roof side 150 and the front supporter 80 to increase the height direction strength of the vehicle body 10 and support the front supporter 80.

According to an example embodiment, the side structure of a vehicle body may further include a front vertical supporter 110 connecting the front supporter 80 and the side sill 140.

A vertical support upper flange 112 can be formed at the upper part of the front vertical supporter 110 and can be connected to the front supporter 80, and a vertical support lower flange 114 can be formed at the lower part of the front vertical supporter 110 and can be connected to the side sill 140.

The front vertical supporter 110 can connect the front supporter 80 and the side sill 140 to support the front supporter 80 and disperse side loads of the vehicle body.

The configuration corresponding to the side impact of the vehicle body can be a major factor in the safety evaluation of the vehicle body. According to an example embodiment, the side structure of a vehicle body can strengthen the side strength by connecting the second supporter 102 and the front vertical supporter 110 with the front supporter 80 and the side sill 140, and this configuration can overlap with the position of the barrier (SCT; referring to FIG. 4) used in the vehicle's side collision test and can support the side structure during side collision.

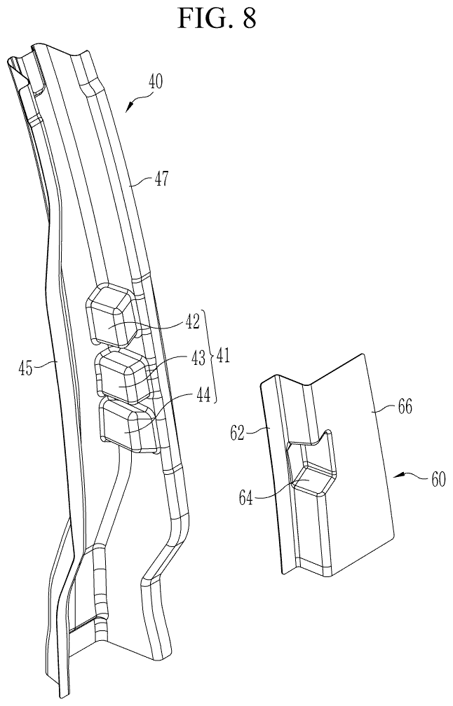

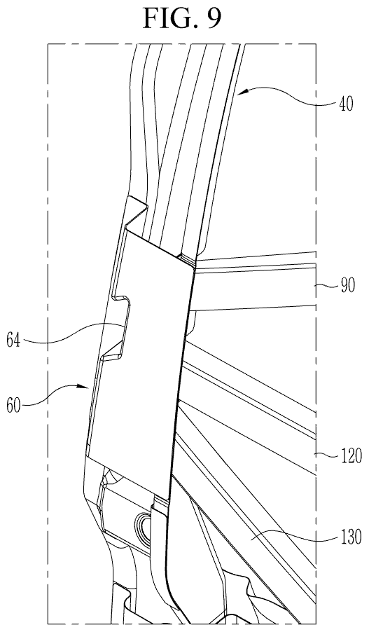

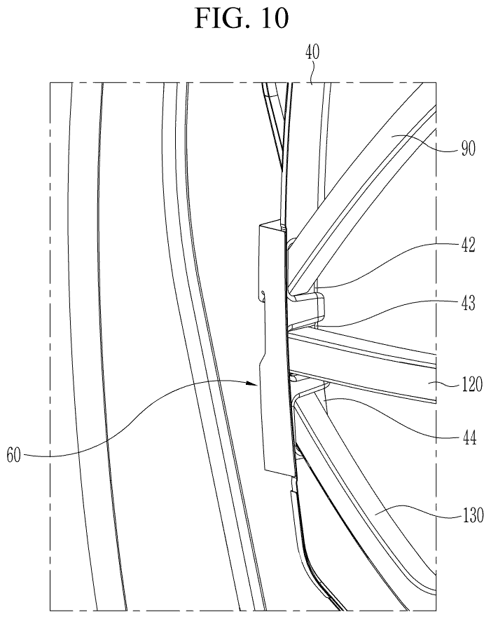

FIG. 8 is an exploded perspective view of a center pillar of the variable part applied to the side structure of a vehicle body according to an example embodiment. FIG. 9 and FIG. 10 are perspective views of a center pillar viewed from the outside of the variable part applied to the side structure of a vehicle body according to an example embodiment.

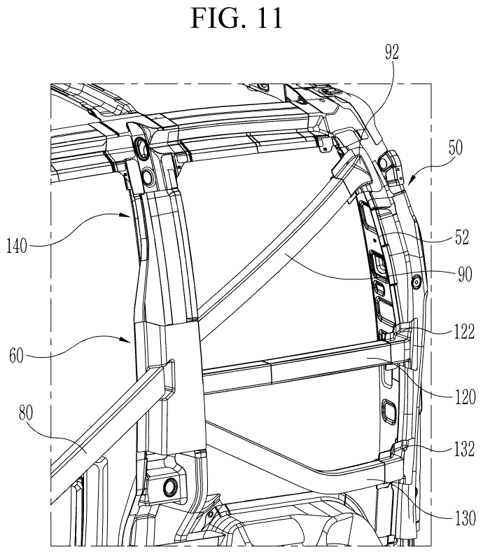

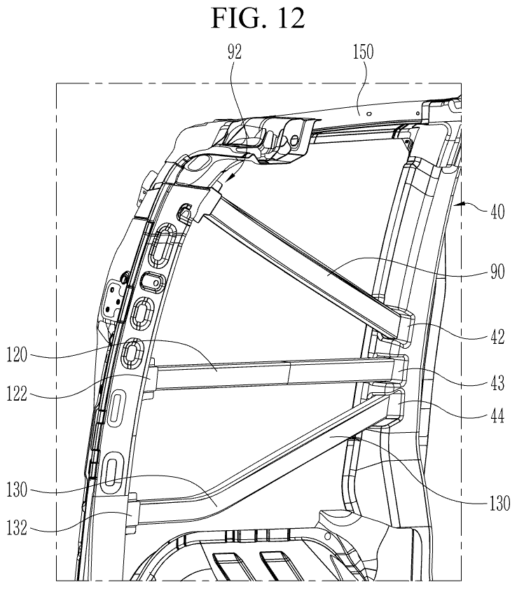

FIG. 11 is a perspective view of a rear part seen from the outside of the variable section applied to the side structure of a vehicle body according to an example embodiment. FIG. 12 is a perspective view of the rear part seen from the inside of the variable section applied to the side structure of a vehicle body according to an example embodiment.

Referring to FIG. 1 to FIG. 12, according to an example embodiment, the side structure of a vehicle body may include a center pillar 40 formed with a center pillar mounting portion 41 supporting the supporter, and the center pillar bracket 60 formed with a center pillar bracket mounting portion 64 supporting the supporter and connected with the center pillar 40.

The center pillar 40 can include a center pillar front flange 45 formed in the front direction of the vehicle body 10, and a center pillar rear flange 47 formed in the rear direction of the vehicle body 10. And the center pillar bracket 60 can include a center pillar bracket front flange 62, which can be connected to the center pillar front flange 45, and a center pillar bracket rear flange 66 can be connected to the center pillar rear flange 47.

The center pillar bracket mounting portion 64 may be formed in the front direction of the vehicle body 10 of the center pillar bracket 60, and the front supporter 80 may be mounted on the center pillar bracket mounting portion 64.

The center pillar mounting portion 41 may be formed in plural on the center pillar 40 in the rear direction of the vehicle body 10.

The plurality of the center pillar mounting portions 41 can include a center pillar central mounting portion 43, and a rear center supporter 120 can be supported by the center pillar central mounting portion 43 and connected to the rear pillar 50.

The plurality of the center pillar mounting portions 41 can further include a center pillar lower mounting portion 44 formed below the center pillar central mounting portion 43. And a rear lower supporter 130 can be disposed below the rear center supporter 120, can be supported by the center pillar lower mounting portion 44, and can be connected with the rear pillar 50.

The plurality of center pillar mounting portions 41 can further include a center pillar upper mounting portion 42 formed on above the center pillar central mounting portion 43. And a rear upper supporter 90 can be disposed above the rear center supporter 120, can be supported by the center pillar upper mounting portion 42, and can be connected with the rear pillar 50.

The rear upper supporter 90 may be placed in a position corresponding to the glass mounting portion 18 formed at the rear of the vehicle body 10. For example, if the glass is not mounted on the glass mounting portion 18, the rear upper supporter 90 can connect the center pillar 40 and the rear pillar 50 to disperse loads in the length direction and vertical direction of the vehicle body 10.

According to an example embodiment, the side structure of a vehicle body may further include one or more rear supporters 90, 120, and 130 supported by the center pillar rear mounting portion 41 and connected to the rear pillar 50, and one or more rear support bracket 92, 122, and 132 mounting the one or more rear supporter 90, 120, and 130, respectively, to the rear pillar 50.

The rear pillar 50 can include a rear pillar flange 52 formed in the front direction of the vehicle body 10, and the one or more rear support bracket 92, 122, and 132 may surround the rear pillar flange 52 and may be connected with the one or more rear supporter 90, 120, and 130, respectively.

The rear upper support bracket 92 may surround the rear pillar flange 52 and mount the rear upper supporter 90 on the rear pillar 50.

The rear center support bracket 122 may surround the rear pillar flange 52 and mount the rear center supporter 120 on the rear pillar 50.

The rear lower support bracket 132 may surround the rear pillar flange 52 and mount the rear lower supporter 130 on the rear pillar 50.

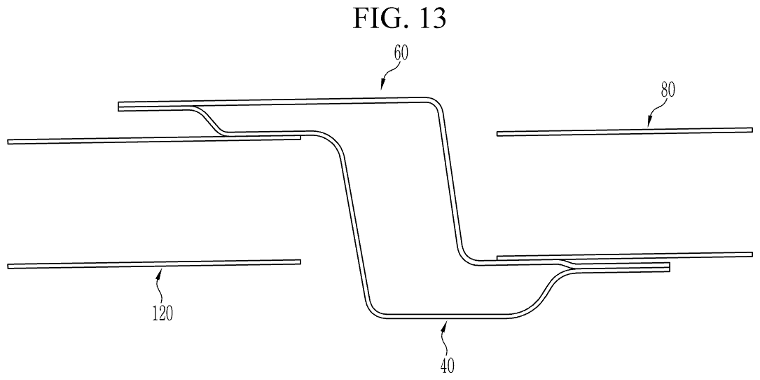

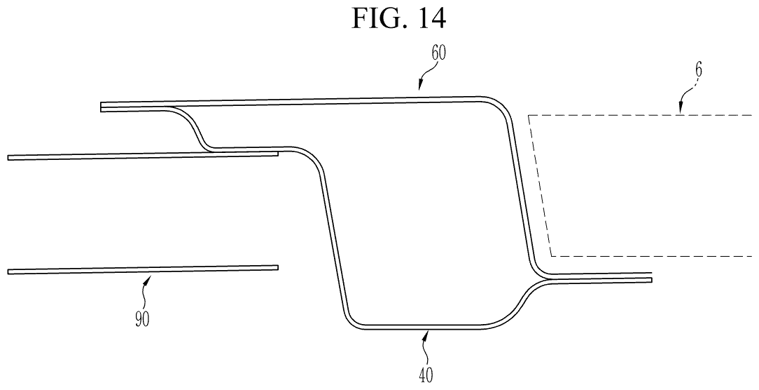

FIG. 13 is a cross-sectional view along line A-A in FIG. 3. FIG. 14 is a cross-sectional view along line B-B in FIG. 3.

Referring to FIG. 13 and FIG. 14, the center pillar 40 and the center pillar bracket 60 can be combined to form a closed space inside, thereby securing and increasing the strength of the center pillar 40.

The center pillar 40 and the center pillar bracket 60 may support the front supporter 80, the rear center supporter 120, and the rear upper supporter 90. In the case of a vehicle with the door 6 mounted, the door 6 can be mounted at the position of the front supporter 80, and the center pillar 40 and the center pillar bracket 60 may serve as an opening flange to support the door 6.

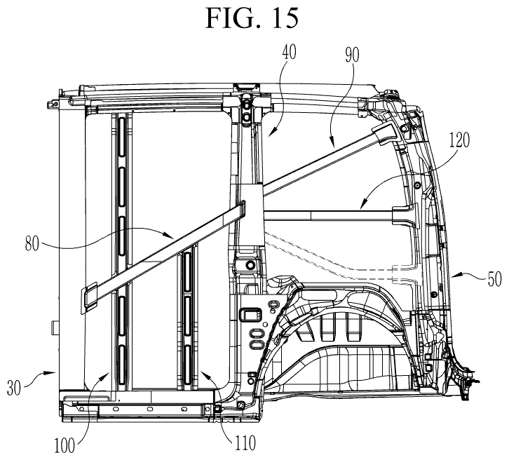

FIG. 15 to FIG. 18 are side views showing a vehicle body to which the side structure of a vehicle body according to an example embodiment has been applied.

The vehicle body shown in FIG. 15 is a vehicle without doors and glass, and the front supporter 80, the door mounting portion supporter 100, the front vertical supporter 110, the rear upper supporter 90, and the rear center supporter 120 may be mounted.

In this case, the rear lower supporter 130 may be mounted selectively according to the demand for increased strength.

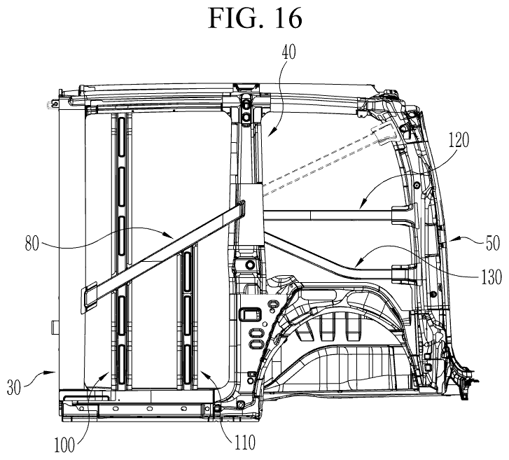

The vehicle body shown in FIG. 16 is a vehicle to which glass is applied without a door, and the front supporter 80, the door mounting portion supporter 100, the front vertical supporter 110, the rear center supporter 120, and the rear lower supporter 130 may be mounted.

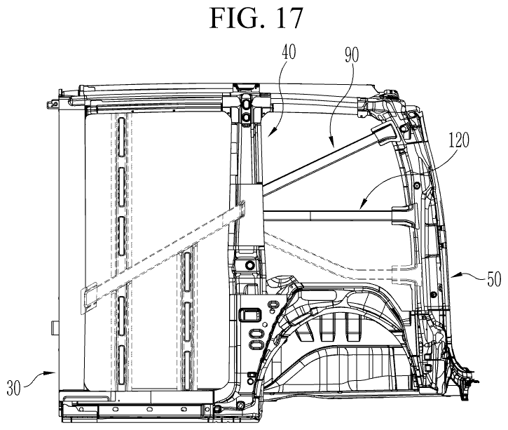

The vehicle body shown in FIG. 17 is a vehicle with a door applied and no glass applied, and the rear upper supporter 90 and the rear center supporter 120 may be mounted.

In this case, the rear lower supporter 130 may be mounted selectively according to the demand for increased strength.

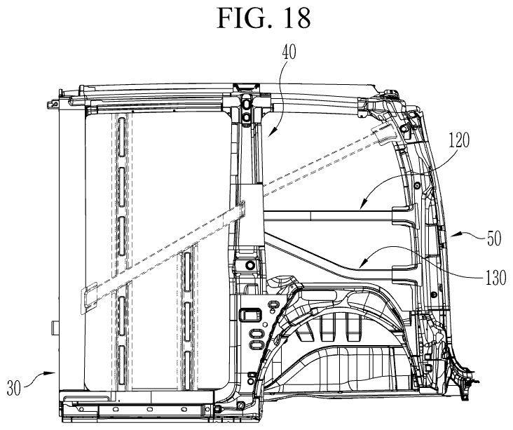

The vehicle body shown in FIG. 18 is a vehicle with doors and glass applied, and the rear center supporter 120 and the rear lower supporter 130 may be mounted.

As shown in FIG. 15 to in FIG. 18, the rear center supporter 120 can be always applied, but other supporters may be applied selectively depending on the type and needs of the vehicle.

However, according to an example embodiment, the side structure of a vehicle body does not require separate design and parts according to the type and needs of the vehicle, and design and production costs may be reduced by applying common specifications and parts.

While example embodiments of this disclosure have been described in connection with what is presently considered to be practical example embodiments, it can be understood that other embodiments of the disclosure are not necessarily limited by the disclosed embodiments. On the contrary, the present disclosure can cover various modifications and equivalent arrangements included within the spirit and scopes of the appended claims.

What is claimed is:

1. A side structure of a vehicle body comprising:
a center pillar having a center pillar mounting portion supporting a supporter; and
a center pillar bracket to which a center pillar bracket mounting portion is formed to support the supporter, and the center pillar bracket being connected to the center pillar.

2. The structure of claim 1, wherein the center pillar comprises:
a center pillar front flange extending in a front direction of the vehicle body, and
a center pillar rear flange extending in a rear direction of the vehicle body; and
wherein the center pillar bracket comprises:
a center pillar bracket front flange connected to the center pillar front flange, and
a center pillar bracket rear flange connected to the center pillar rear flange.

3. The structure of claim 2, wherein the center pillar bracket mounting portion extends in the front direction of the vehicle body of the center pillar bracket.

4. The structure of claim 3, wherein the center pillar mounting portion is formed in plural in the rear direction of the vehicle body of the center pillar.

5. The structure of claim 4, wherein the plurality of center pillar mounting portions include:
a center pillar central mounting portion, and
wherein the side structure further includes:
a rear pillar disposed at a rear of the center pillar; and
a rear center supporter supported by the center pillar central mounting portion and connected to the rear pillar.

6. The structure of claim 5, wherein the plurality of center pillar mounting portions include a center pillar lower mounting portion formed below the center pillar central mounting portion, and
wherein the side structure further includes a rear lower supporter disposed below the rear center supporter, supported by the center pillar lower mounting portion, and connected to the rear pillar.

7. The structure of claim 5, wherein the plurality of center pillar mounting portions further include a center pillar upper mounting portion formed above the center pillar central mounting portion, and
wherein the side structure further includes a rear upper supporter disposed above the rear center supporter, supported by the center pillar upper mounting portion, and connected to the rear pillar, and
wherein the rear upper supporter is disposed in a position corresponding to a glass mount portion formed on the rear of the vehicle body.

8. The structure of claim 4, further comprises:
a rear pillar disposed at a rear of the center pillar;
one or more rear supporters supported by a rear portion of the center pillar mounting portion and connected to the rear pillar; and
one or more rear support brackets mounting the one or more rear supporters to the rear pillar.

9. The structure of claim 8, wherein the rear pillar further includes a rear pillar flange extending in the front direction of the vehicle body, and
wherein the one or more rear support brackets are connected to the one or more rear supporters, respectively.

10. The structure of claim 3, further comprises:
a front pillar disposed at a front of the center pillar; and
a front supporter supported by the center pillar bracket mounting portion and connected to the front pillar.

11. The structure of claim 10, further comprising a variable part connecting portion mounted on the front pillar, and wherein the front supporter is disposed toward the variable part connecting portion.

12. The structure of claim 10, wherein the front pillar includes a front pillar flange extending in the rear direction of the vehicle body, and
wherein the side structure further includes a front support bracket surrounding and connecting the front supporter and the front pillar flange.

13. The structure of claim 10, further comprising a door mounting portion supporter that connects a side sill and a roof side, and is mounted between the front pillar and the center pillar.

14. The structure of claim 13, wherein the door mounting portion supporter comprises:
a first supporter connecting the roof side and the front supporter; and
a second supporter connecting the front supporter and the side sill.

15. The structure of claim 10, further comprising a front vertical supporter connecting the front supporter and a side sill.

16. A side structure for a modular vehicle upper body portion comprising:
a center pillar; and
means for providing multiple connection points on the center pillar for required and optional braces implemented depending on a customization of the modular vehicle upper body portion.

17. The structure of claim 16, further comprising means for strengthening the modular vehicle upper body portion using a selection of the optional braces when a side door is omitted.

18. The structure of claim 16, further comprising means for strengthening the modular vehicle upper body portion using a selection of the optional braces when a glass window is omitted.

19. The structure of claim 16, further comprising means for strengthening the modular vehicle upper body portion using a selection of the optional braces when a side door and a glass window are omitted.

20. A side structure of a vehicle body comprising:
a center pillar having a center pillar mounting portion supporting a supporter, wherein the center pillar includes:
a center pillar front flange extending in a front direction of the vehicle body, and
a center pillar rear flange extending in a rear direction of the vehicle body;
a center pillar bracket to which a center pillar bracket mounting portion is formed to support the supporter, wherein the center pillar bracket is connected to the center pillar, wherein the center pillar bracket mounting portion extends in the front direction of the vehicle body of the center pillar bracket, wherein the center pillar mounting portion is formed in plural in the rear direction of the vehicle body of the center pillar, wherein the plurality of center pillar mounting portions include a center pillar central mounting portion, and wherein the center pillar bracket includes:
a center pillar bracket front flange connected to the center pillar front flange, and
a center pillar bracket rear flange connected to the center pillar rear flange;
a rear pillar disposed at a rear of the center pillar; and
a rear center supporter supported by the center pillar central mounting portion and connected to the rear pillar,
wherein the plurality of center pillar mounting portions include a center pillar lower mounting portion formed below the center pillar central mounting portion, and
wherein the side structure further includes a rear lower supporter disposed below the rear center supporter, supported by the center pillar lower mounting portion, and connected to the rear pillar,
wherein the plurality of center pillar mounting portions further include a center pillar upper mounting portion formed above the center pillar central mounting portion, and
wherein the side structure further includes a rear upper supporter disposed above the rear center supporter, supported by the center pillar upper mounting portion, and connected to the rear pillar, and
wherein the rear upper supporter is disposed in a position corresponding to a glass mount portion formed on the rear of the vehicle body;
a front pillar disposed at a front of the center pillar; and
a front supporter supported by the center pillar bracket mounting portion and connected to the front pillar, wherein the front pillar includes a front pillar flange extending in the rear direction of the vehicle body;
a front support bracket surrounding and connecting the front supporter and the front pillar flange;
a variable part connecting portion mounted on the front pillar, and wherein the front supporter is disposed toward the variable part connecting portion; and
a front vertical supporter connecting the front supporter and a side sill.
